(19) United States
(12) Patent Application Publication
(10) Pub. No.: US 2020/0036245 A1
(43) Pub. Date: Jan. 30, 2020

(54) ROTARY ELECTRIC MACHINE AND VEHICLE CARRYING ROTARY ELECTRIC MACHINE

(71) Applicant: HONDA MOTOR CO., LTD., Tokyo (JP)

(72) Inventors: Yoshihisa KUBOTA, Wako-shi (JP); Yuta ITO, Wako-shi (JP)

(21) Appl. No.: 16/522,219

(22) Filed: Jul. 25, 2019

(30) Foreign Application Priority Data
Jul. 30, 2018 (JP) 2018-142251

(51) Int. Cl. H02K 1/27; H02K 1/16

(52) U.S. Cl. CPC H02K 1/2766; H02K 29/03; H02K 1/16

(57) ABSTRACT

A rotary electric machine is provided which includes: an annular stator comprising a stator core and coils included in the stator core; and an annular rotor comprising a rotor core and a plurality of housing holes for magnetic bodies extending in a drive shaft direction, the housing holes being arranged in a circumferential direction, the rotor facing, via a gap, an inner periphery of the stator. Each magnetic body includes a hard magnetic body and a soft magnetic body. The soft magnetic body is stacked in a magnetization direction of the hard magnetic body. Each housing hole houses the magnetic body comprising the hard magnetic body and the soft magnetic body.

### TECHNICAL FIELD

The present invention relates to a highly efficient operation-achievable rotary electric machine and a vehicle carrying the rotary electric machine.

### BACKGROUND ART

Nowadays, to address the problem of realizing low-carbon societies, widely used are vehicles carrying a rotating electric machine in addition to or instead of an internal-combustion engine as a driving source of each vehicle. Examples of the vehicles include what is called hybrid electric vehicles and electric vehicles.

Each rotary electric machine includes an annular stator and a cylindrical rotor. The stator includes a stator core provided with a plurality of slots, each slot having a stator coil. The rotor is rotatably provided via a small gap to an inner periphery of the stator. The rotor includes a rotor core provided with a plurality of permanent magnets placed with an equal distance in the circumferential direction thereof.

In the rotary electric machine, when a motor current flows through each stator coil, a rotating magnetic field occurs at the stator. The rotating magnetic field as so generated at the stator interacts with a magnetic field generated at the rotor by each permanent magnet included in the rotor core, thereby driving rotation of the rotor. In such a rotary electric machine, there is a strong need to perform a highly efficient (high output) operation at an appropriate rotation speed and torque depending on the operation state so as to save the energy.

Japanese Patent Application Publication No. 2010-057209 describes an invention of a variable-field rotary electric machine in which a stator can be displaced relative to a rotor in the shaft direction and the stator is displaced in the shaft direction by external operation so as to be capable of controlling a variable field at will.

The variable-field rotary electric machine according to JP2010-057209A makes it possible to achieve a highly efficient (high output) operation at an appropriate rotation speed and torque depending on the operation state

### SUMMARY OF INVENTION

Unfortunately, in order to achieve a highly efficient operation by using a variable field, the variable-field rotary electric machine according to JP2010-057209A needs an additional actuator for displacing the stator relative to the rotor in the shaft direction. Here, there has been a problem to be solved because the above causes the weight and size of the rotary electric machine to increase.

The present invention provides a solution to the problem. The purpose of the present invention is to provide, without causing the weight and size to increase, a highly efficient operation-achievable rotary electric machine and a vehicle carrying the rotary electric machine.

An aspect of the present invention provides a rotary electric machine is provided which includes: an annular stator comprising a stator core and coils included in the stator core; and an annular rotor comprising a rotor core and a plurality of housing holes for magnetic bodies extending in a drive shaft direction, the housing holes being arranged in a circumferential direction, the rotor facing, via a gap, an inner periphery of the stator. Each magnetic body includes a hard magnetic body and a soft magnetic body. The soft magnetic body is stacked in a magnetization direction of the hard magnetic body. Each housing hole houses the magnetic body comprising the hard magnetic body and the soft magnetic body.

The present invention may make it possible to produce, without causing the weight and size to increase, a highly efficient operation-achievable rotary electric machine.

### BRIEF DESCRIPTION OF DRAWINGS

FIG. 1A is a front view of a rotary electric machine according to the present invention.

FIG. 1B is a magnified view of surroundings of a magnetic pole section provided in a rotor included in the rotary electric machine illustrated in FIG. 1A.

FIG. 1C is a magnified front view of a first layered structure of a soft magnetic body in a magnetic body having a function of generating a magnet magnetic flux at or near the magnetic pole section shown in FIG. 1B.

FIG. 1D is a front view of a layered structure of a hard magnetic body in the magnetic body shown in FIG. 1C.

FIG. 1E is a side view of the magnetic body shown in FIG. 1D when viewed from the arrow direction.

FIG. 1F is a side view of a modification embodiment of the magnetic body shown in FIG. 1E.

FIG. 1G is a magnified view of a second layered structure of a soft magnetic body in a magnetic body having a function of generating a magnet magnetic flux at or near the magnetic pole section shown in FIG. 1B.

FIG. 1H is a front view of a layered structure of a hard magnetic body in the magnetic body illustrated in FIG. 1G.

FIG. 1I is a side view of the magnetic body shown in FIG. 1H when viewed from the arrow direction.

FIG. 1J is a side view of a modification embodiment of the magnetic body shown in FIG. 1I.

FIG. 1K is a side view of a modification embodiment of the magnetic body shown in FIG. 1J.

FIG. 1L is a magnified front view of a third layered structure of a soft magnetic body in a magnetic body having a function of generating a magnet magnetic flux at or near the magnetic pole section shown in FIG. 1B.

FIG. 2A is a front view of a rotary electric machine according to a comparative embodiment.

FIG. 2B is a magnified view of surroundings of a magnetic pole section provided in a rotor included in the rotary electric machine illustrated in FIG. 2A.

FIG. 3A is a diagram illustrating a case where a rotary electric machine according to the present invention is needed in the art.

FIG. 3B is a diagram illustrating a case where a rotary electric machine according to the present invention is needed in the art.

FIG. 4A is a contour plot illustrating a distribution of magnetic flux density at or near each magnetic body in a rotary electric machine according to a comparative embodiment (under no load).

FIG. 4B is a contour plot illustrating a distribution of magnetic flux density at or near each magnetic body in the rotary electric machine according to the comparative embodiment (under high load).

FIG. 5A is a contour plot illustrating a distribution of magnetic flux density at or near each magnetic body in a rotary electric machine according to the present invention (under no load).

FIG. 5B is a contour plot illustrating a distribution of magnetic flux density at or near each magnetic body in the rotary electric machine according to the present invention (under high load).

FIG. 6A is a graph using characteristic lines to compare an effective current vs. torque change between the present invention and a comparative embodiment.

FIG. 6B is a graph using characteristic lines to compare an effective current vs. magnet magnetic flux change between the present invention and the comparative embodiment.

FIG. 6C is a graph using characteristic lines to compare a rotation speed vs. voltage change between the present invention and the comparative embodiment.

FIG. 6D is a graph using characteristic lines to compare a rotation speed vs. electric power change between the present invention and the comparative embodiment.

FIG. 6E is a graph using characteristic lines to compare a rotation speed vs. core loss change under no load between the present invention and the comparative embodiment.

### DESCRIPTION OF EMBODIMENTS

With reference to the appropriate Drawings, the following details rotary electric machines and a vehicle carrying each rotary electric machine according to embodiments of the present invention.

Note that in the following figures, the same members or corresponding members have the same reference numerals. In addition, the size and shape of each member may be modified or schematically exaggerated for description convenience.

[Basic Structure of Rotary Electric Machine 11 According to the Present Invention]

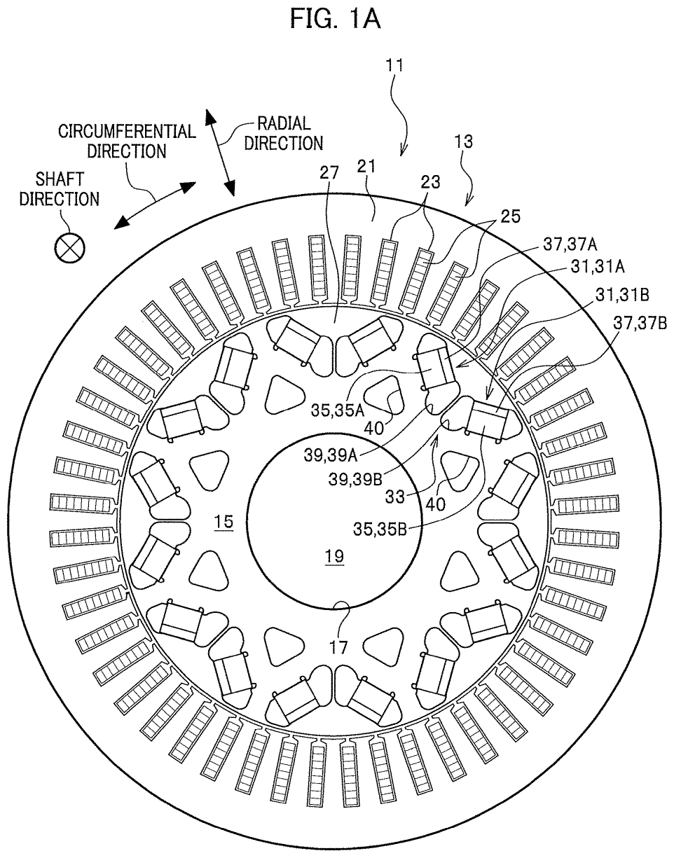

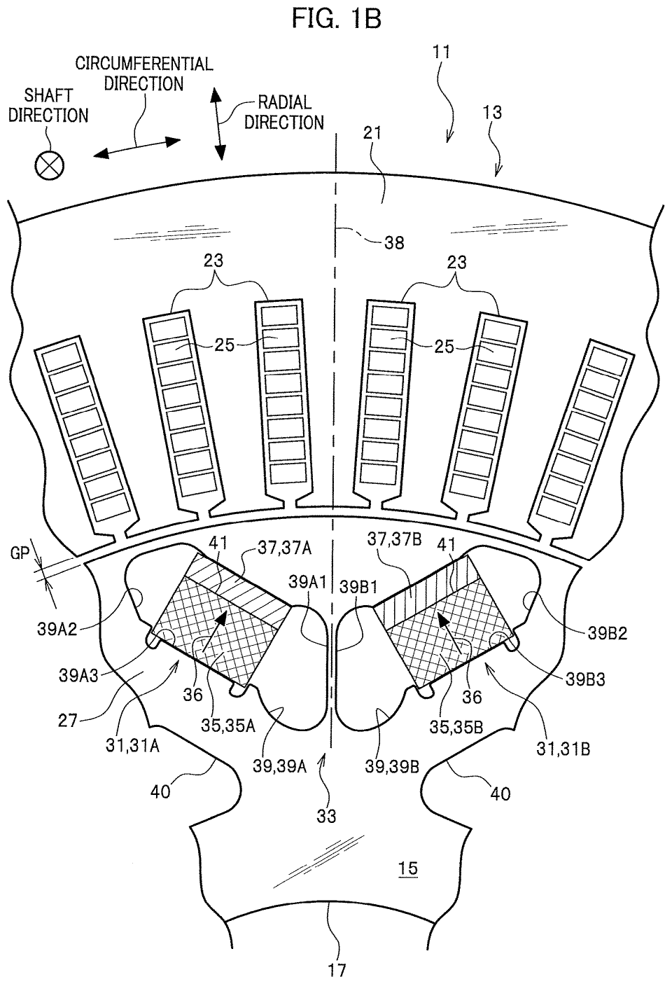

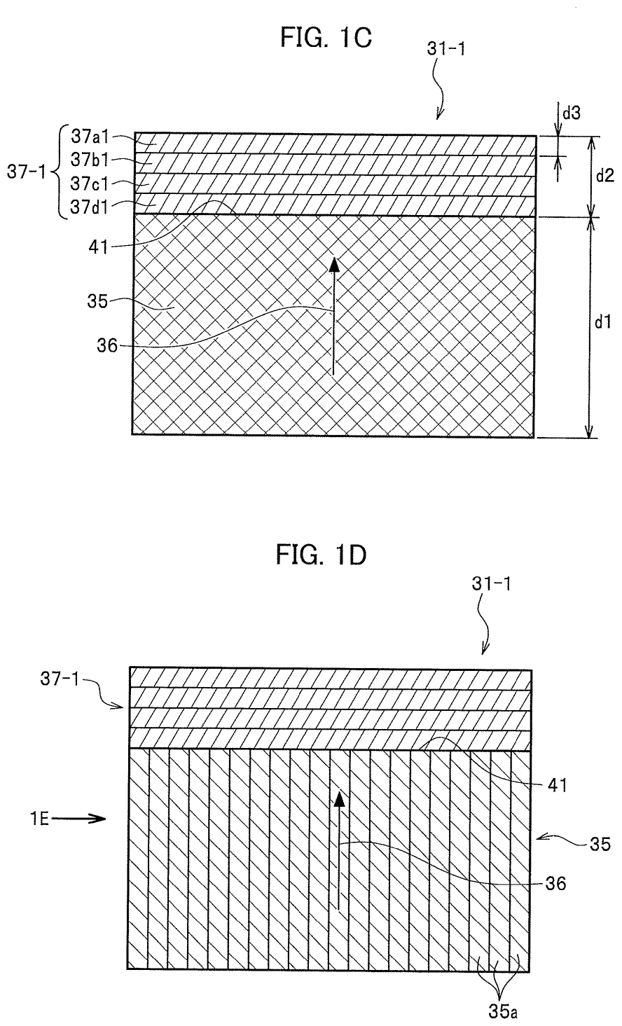

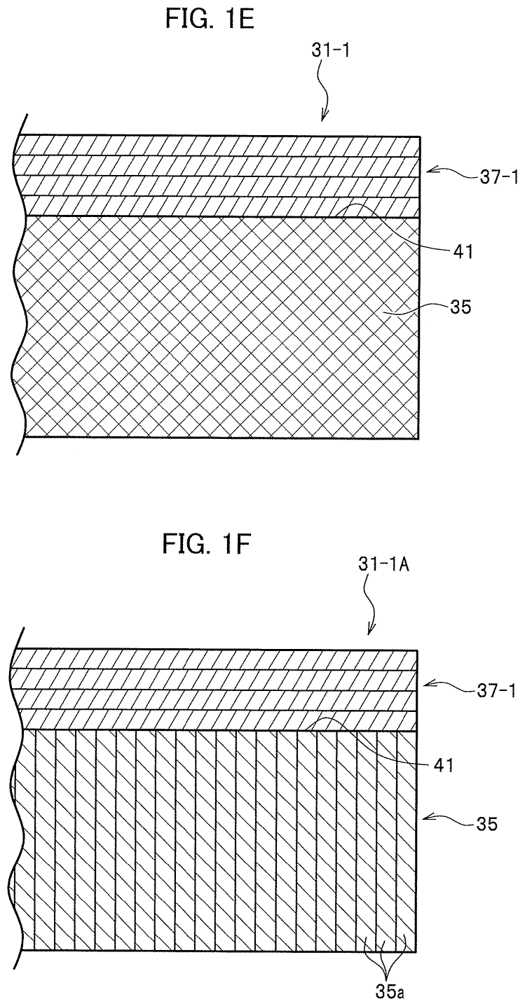

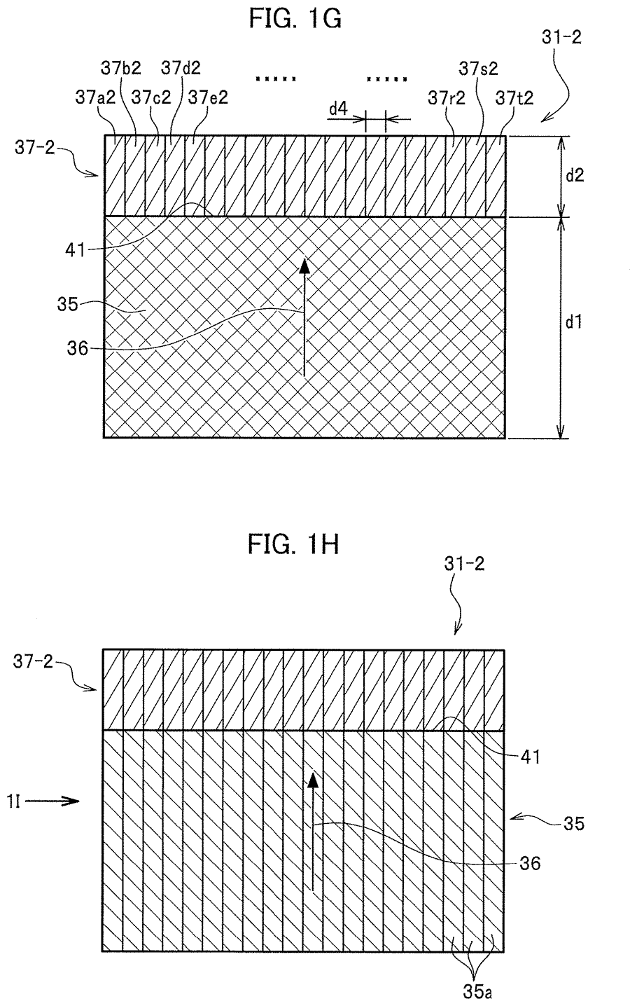

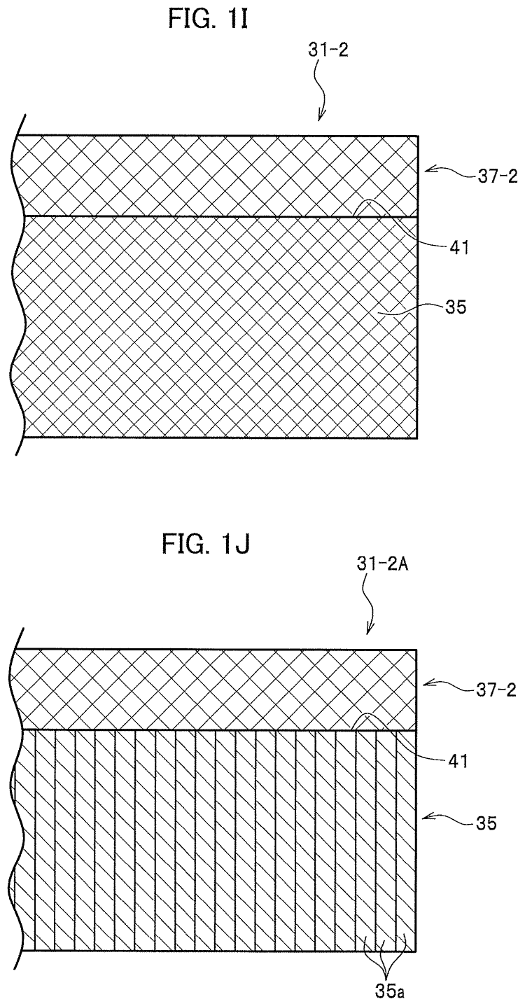

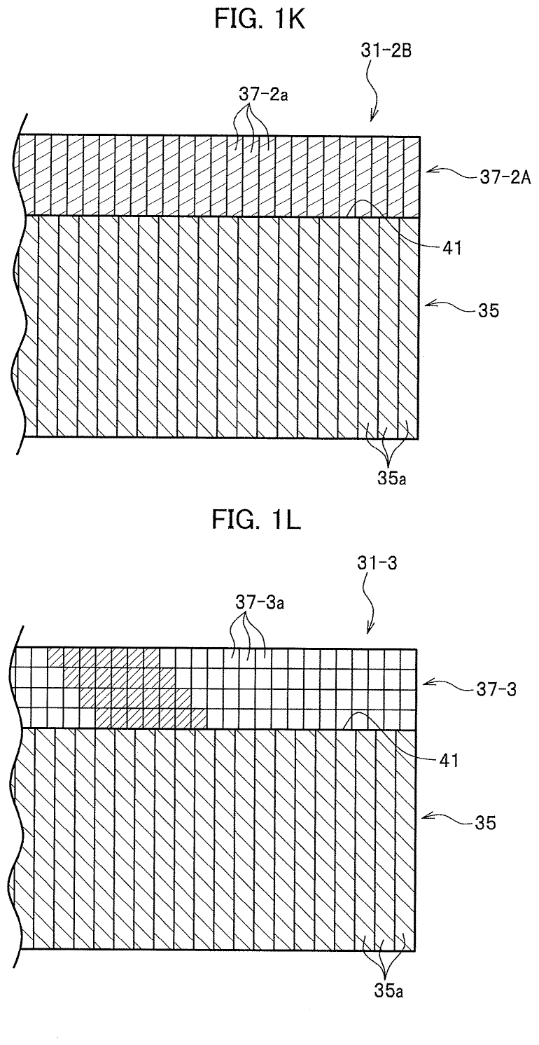

First, with reference to FIGS. 1A to 1L, the following details the basic structure of a rotary electric machine 11 according to an embodiment of the present invention.

FIG. 1A is a front view of the rotary electric machine 11 according to this embodiment.

FIG. 1B is a magnified view of surroundings of a magnetic pole section 33 provided in a rotor 15 included in the rotary electric machine 11 illustrated in FIG. 1A.

FIG. 1C is a magnified front view of a first layered structure 37-1 of a soft magnetic body 37 in a magnetic body 31 having a function of generating a magnet magnetic flux at or near the magnetic pole section 33 shown in FIG. 1B.

FIG. 1D is a front view of a layered structure of a hard magnetic body 35 in the magnetic body 31 shown in FIG. 1C.

FIG. 1E is a side view of the magnetic body 31 shown in FIG. 1D when viewed from the arrow direction.

FIG. 1F is a side view of a modification embodiment of the magnetic body 31 shown in FIG. 1E.

FIG. 1G is a magnified front view of a second layered structure 37-2 of a soft magnetic body 37 in a magnetic body 31 having a function of generating a magnet magnetic flux at or near the magnetic pole section 33 shown in FIG. 1B.

FIG. 1H is a front view of a layered structure of a hard magnetic body 35 in the magnetic body 31 shown in FIG. 1G.

FIG. 1I is a side view of the magnetic body 31 shown in FIG. 1H when viewed from the arrow direction.

FIG. 1J is a side view of a modification embodiment of the magnetic body 31 shown in FIG. 1I.

FIG. 1K is a side view of a modification embodiment of the magnetic body 31 shown in FIG. 1J.

FIG. 1L is a magnified front view of a third layered structure 37-3 of a soft magnetic body 37 in a magnetic body 31 having a function of generating a magnet magnetic flux at or near the magnetic pole section 33 shown in FIG. 1B.

As shown in FIG. 1A, the rotary electric machine 11 according to this embodiment includes an annular stator 13 and an annular rotor 15.

As shown in FIG. 1A, the stator 13 includes a stator core 21 and a plurality of slots 23 included in the stator core 21, each slot 23 having a stator coil 25.

As shown in FIG. 1A, the stator core 21 has a cylindrical shape as a whole. The stator core 21 may be structured by stacking, for example, a plurality of annular magnetic steel sheets in a shaft direction (axial direction).

As shown in FIG. 1B, the annular rotor 15 faces, via a small gap GP, an inner periphery of the stator 13.

As shown in FIGS. 1A and 1B, the rotor 15 includes a rotor core 27 and magnetic pole sections 33. The rotor core 27 has a cylindrical through-hole 17 on an inner circumference side. A rotation shaft 19 is fit for the through-hole 17 of the rotor core 27 such that the inner circumference side of the through-hole 17 is connected to the outer circumferential side of the rotation shaft 19. This makes the rotation shaft 19 fit for and fixed to the through-hole 17 of the rotor core 27.

Like the stator core 21, the rotor core 27 may be structured by stacking, for example, a plurality of annular magnetic steel sheets in the shaft direction. As shown in FIGS. 1A and 1B, the rotor core 27 includes a plurality of magnetic pole sections 33 arranged with a prescribed interval in a circumferential direction, each magnetic pole section having magnetic bodies 31 extending straight in the shaft direction. In addition, the rotor core 27 includes a plurality of housing holes 39 arranged with a given interval in the circumferential direction, each housing hole housing a magnetic body 31. The structure of each housing hole 39 is described in detail below. Further, the rotor core 27 has cavities 40 which are each formed throughout in the shaft direction and each have an approximately triangular cross section (see FIG. 1B).

Each magnetic body 31 is made of a rod-shaped magnetic member with an approximately rectangular cross section. The length of each magnetic body 31 is set to substantially the same length of the whole rotor 15 in the shaft direction.

Specifically, as illustrated in FIGS. 1A and 1B, each magnetic body 31 includes a hard magnetic body 35 and a soft magnetic body 37.

The hard magnetic body 35 is made of hard magnetic material. Examples of the hard magnetic material that can be suitably used include, but are not particularly limited to, rare-earth element magnets, such as a neodymium magnet, having increased magnetic characteristics so as to achieve high torque density.

Meanwhile, the soft magnetic body 37 is made of soft magnetic material. Examples of the soft magnetic material that can be suitable used include permalloy having a lower saturation magnetization characteristic than a residual magnetic flux density induced by (the hard magnetic material of) the hard magnetic body 35 and having a higher maximum magnetic permeability than the maximum magnetic permeability of each magnetic steel sheet as a material of the rotor 15. Note that how the soft magnetic body 37 is arranged and structured relative to the hard magnetic body 35 is described in detail below.

In an example shown in FIGS. 1A and 1B, one magnetic pole section 33 is constructed by combining a pair of first and second magnetic bodies 31A and 31B.

The first magnetic body 31A includes a first hard magnetic body 35A and a first soft magnetic body 37A. Meanwhile, the second magnetic body 31B includes a second hard magnetic body 35B and a second soft magnetic body 37B.

As used herein, the first and second magnetic bodies 31A and 31B are each generally and simply referred to as the “magnetic body 31”. The first and second hard magnetic bodies 35A and 35B are each generally and simply referred to as the “hard magnetic body 35”. The first and second soft magnetic bodies 37A and 37B are each generally and simply referred to as the “soft magnetic body 37”.

As shown in FIG. 1B, the paired first and second magnetic bodies 31A and 31B are symmetric with respect to a radially extending center line 38, are inclined radially outward (see FIG. 1B), and are disposed like an approximately V-shape.

As shown in FIGS. 1A and 1B, in order to house the pair of first and second magnetic bodies 31A and 31B, first and second housing holes 39A and 39B are created in the rotor 15. Like the paired first and second magnetic bodies 31A and 31B, the first and second housing holes 39A and 39B are symmetric with respect to the center line 38, are inclined radially outward (see FIG. 1B), and are disposed like an approximately V-shape.

The first housing hole 39A continuously and integrally includes: a first inside space 39A1 positioned on the center line 38 side; a first outside space 39A2 positioned radially outward; and a first housing portion 39A3 interposed between the first inside space 39A1 and the first outside space 39A2 so as to house the first magnetic body 31A.

Then, like the first housing hole 39A, the second housing hole 39B continuously and integrally includes: a second inside space 39B1 positioned on the center line 38 side; a second outside space 39B2 positioned radially outward; and a second housing portion 39B3 interposed between the second inside space 39B1 and the second outside space 39B2 so as to house the second magnetic body 31B.

As used herein, the first and second housing holes 39A and 39B are each generally and simply referred to as the “housing hole 39”. In addition, the first and second housing portions 39A3 and 39B3 are each generally and simply referred to as the “housing portion 39-3”.

While housed in the housing portion 39-3 of each housing hole 39, each magnetic body 31 is fixed, using, for instance, an adhesive (not shown), to a radially inner wall surface of the housing portion 39-3 (see FIG. 1B).

Paired magnetic bodies 31 included in one magnetic pole section 33 have the same magnet polarity on the radially outward side; and in each adjacent magnetic pole section 33, the magnet polarity is opposite.

Regarding, for instance, the hard magnetic body 35 of the magnetic body 31, there are an easy-to-magnetize direction and a hard-to-magnetize direction. In an example shown in FIG. 1B, the easy-to-magnetize direction 36 (see each arrow of FIG. 1B) of each hard magnetic body 35 is oriented radially outward of the rotor 15.

For instance, as illustrated in FIGS. 1B and 1C to 1L, the soft magnetic body 37 is bonded and fixed, using an adhesive (not shown), to a lateral surface 41 on the easy-to-magnetize direction 36 side of the hard magnetic body 35 as part of the magnetic body 31. As described above, the soft magnetic body 37 has a lower saturation magnetization characteristic than a residual magnetic flux density induced by the hard magnetic body 35 and has a higher maximum magnetic permeability than the maximum magnetic permeability of each magnetic steel sheet as a material of the rotor 15.

This makes it possible for the soft magnetic body 37 to exert a function of decreasing a magnet magnetic flux induced by the hard magnetic body 35.

As shown in FIGS. 1C and 1G, for instance, the height d1 of the hard magnetic body 35 extending along the easy-to-magnetize direction 36 is set to be larger than the height d2 of the soft magnetic body 37 extending in the easy-to-magnetize direction 36. The easy-to-magnetize direction 36 corresponds to a “magnetization direction” of the present invention.

The soft magnetic body 37 as part of the magnetic body 31 is grouped into, for instance, a first soft magnetic body 37-1 having a first layered structure (see FIGS. 1C to 1F), a second soft magnetic body 37-2 having a second layered structure (see FIGS. 1G to 1K), and a third soft magnetic body 37-3 having a third layered structure (see FIG. 1L).

As shown in FIG. 1C, for instance, the first magnetic body 31-1 includes the first soft magnetic body 37-1, having the first layered structure, disposed on a lateral surface 41 on the easy-to-magnetize direction 36 side of the hard magnetic body 35.

As shown in FIG. 1C, the first soft magnetic body 37-1 of the first magnetic body 31-1 is structured by layering a plurality of flat soft magnetic bodies 37a1, 37b1, 37c1, and 37d1 in the easy-to-magnetize direction 36. The plurality of soft magnetic bodies 37a1, 37b1, 37c1, and 37d1 each have an equal height d3. The plurality of soft magnetic bodies 37a1, 37b1, 37c1, and 37d1 are bonded to one another by using an adhesive (not shown).

As shown in FIG. 1D, the hard magnetic body 35 of the first magnetic body 31-1 is structured by layering a plurality of flat hard magnetic bodies 35a in a width direction perpendicular to the easy-to-magnetize direction 36. The plurality of hard magnetic bodies 35a each have an equal width. The plurality of hard magnetic bodies 35a are bonded to one another by using an adhesive.

As shown in FIG. 1E, the hard magnetic body 35 of the first magnetic body 31-1 extends as a whole along the shaft direction.

Provided that as a modification embodiment for the first magnetic body 31-1, the hard magnetic body 35 may be structured by layering a plurality of flat hard magnetic bodies 35a in the shaft direction as shown in FIG. 1F.

By contrast, as shown in FIG. 1G, for instance, the second magnetic body 31-2 includes the second soft magnetic body 37-2, having the second layered structure, disposed on the lateral surface 41 on the easy-to-magnetize direction 36 side of the hard magnetic body 35.

As shown in FIG. 1G, the second soft magnetic body 37-2 of the second magnetic body 31-2 is structured by layering a plurality of flat soft magnetic bodies 37a2, 37b2, 37c2, . . . 37s2, and 37t2 in a direction perpendicular to the easy-to-magnetize direction 36. The plurality of soft magnetic bodies 37a2, 37b2, 37c2, . . . 37s2, and 37t2 each have an equal width d4. The plurality of soft magnetic bodies 37a2, 37b2, 37c2, . . . 37s2, and 37t2 are bonded to one another by using an adhesive (not shown).

As shown in FIG. 1H, the hard magnetic body 35 of the second magnetic body 31-2 is structured by layering a plurality of flat hard magnetic bodies 35a in a width direction perpendicular to the easy-to-magnetize direction 36. The plurality of hard magnetic bodies 35a each have an equal width. The plurality of hard magnetic bodies 35a are bonded to one another by using an adhesive.

As shown in FIG. 1I, the hard magnetic body 35 of the second magnetic body 31-2 extends as a whole along the shaft direction.

Provided that as a modification embodiment for the second magnetic body 31-2, the hard magnetic body 35 may be structured by layering a plurality of flat hard magnetic bodies 35a in the shaft direction as shown in FIG. 1J.

Further, FIG. 1K shows a second magnetic body 31-2B obtained by further modifying the modification embodiment for the second magnetic body 31-2 as illustrated in FIG. 1J, in which a second soft magnetic body 37-2A may be structured by layering a plurality of rectangular soft magnetic bodies 37-2a in the shaft direction (provided that each soft magnetic body 37a is thinner than each soft magnetic body 37a2, 37b2, 37c2, . . . 37s2, or 37t2 shown in FIG. 1G, etc.).

In addition, as shown in FIG. 1L, the third magnetic body 31-3 includes the third soft magnetic body 37-3, having the third layered structure, disposed on the lateral surface 41 on the easy-to-magnetize direction 36 side of the hard magnetic body 35. Note that the third layered structure is a layered structure of the soft magnetic body 37 as obtained by combining the first layered structure and the second layered structure.

As shown in FIG. 1L, the third soft magnetic body 37-3 of the third magnetic body 31-3 is structured by layering a plurality of divided, rectangular rod-shaped soft magnetic bodies 37-3a in both the shaft direction and the easy-to-magnetize direction 36. The plurality of soft magnetic bodies 37-3a each have an equal height and an equal shaft-direction length. The plurality of soft magnetic bodies 37-3a are bonded to one another by using an adhesive.

[Basic Structure of Rotary Electric Machine 111 According to Comparative Embodiment]

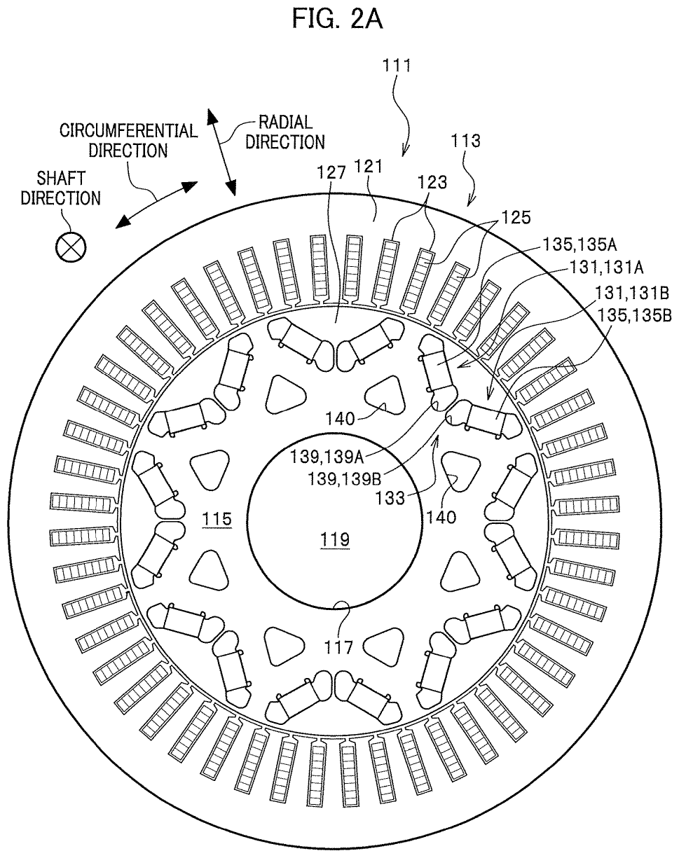

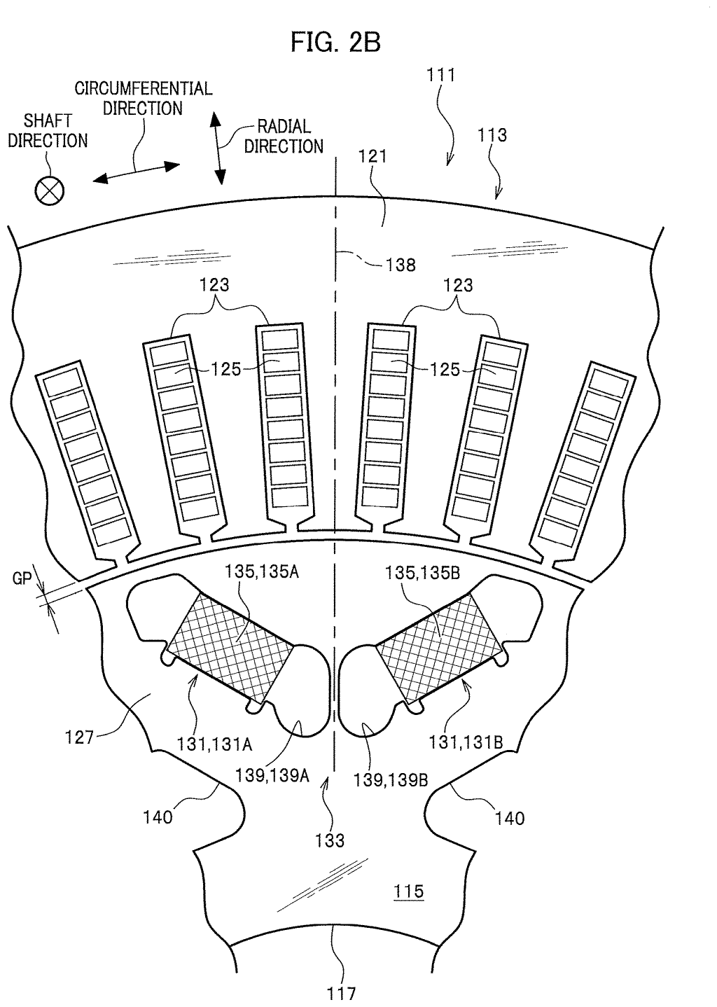

Next, with reference to FIGS. 2A to 2B, the following details the basic structure of a rotary electric machine 111 according to a comparative embodiment.

FIG. 2A is a front view of the rotary electric machine 111 according to the comparative embodiment. FIG. 2B is a magnified view of surroundings of a magnetic pole section 133 provided in a rotor 115 included in the rotary electric machine 111 according to the comparative embodiment illustrated in FIG. 2A.

As shown in FIG. 2A, the rotary electric machine 111 according to this comparative embodiment includes an annular stator 113 and an annular rotor 115.

As shown in FIG. 2A, the stator 113, like the stator 13 according to the present invention, includes a stator core 121 and a plurality of slots 123 included in the stator core 121, each slot 123 having a stator coil 125.

As shown in FIG. 2A, the stator core 121 has a cylindrical shape as a whole. The stator core 121 is structured by stacking a plurality of annular magnetic steel sheets in a shaft direction.

As shown in FIG. 2B, the annular rotor 115 faces, via a small gap GP, an inner periphery of the stator 113.

As shown in FIGS. 2A and 2B, the rotor 115, like the rotor 15 according to the present invention, includes a rotor core 127 and magnetic pole sections 133. As shown in FIG. 2A, the rotor core 127 has a cylindrical through-hole 117 on an inner circumference side. A rotation shaft 119 is fit for the through-hole 117 of the rotor core 127 such that the inner circumference side of the through-hole 117 is connected to the outer circumferential side of the rotation shaft 119. This makes the rotation shaft 119 fit for and fixed to the through-hole 117 of the rotor core 127.

Like the stator core 121, the rotor core 127 is structured by stacking a plurality of annular magnetic steel sheets in the shaft direction.

As shown in FIGS. 2A and 2B, the rotor core 127 includes a plurality of magnetic pole sections 133 arranged with a prescribed interval in a circumferential direction, each magnetic pole section having magnetic bodies 131 extending straight in the shaft direction. In addition, the rotor core 127 includes a plurality of housing holes 139 arranged with a given interval in the circumferential direction, each housing hole housing a magnetic body 131. Further, the rotor core 127 has cavities 140 which are each formed throughout in the shaft direction and each have an approximately triangular cross section (see FIG. 2A).

Each magnetic body 131 is made of a rod-shaped magnetic member with an approximately rectangular cross section. The length of each magnetic body 131 is set to substantially the same length of the whole rotor 115 in the shaft direction. Here, the height (the size in the radial direction) and the width (the size in the circumferential direction) of the magnetic body 131 made of only the hard magnetic body 135 are set to the same height (the size in the radial direction) and width (the size in the circumferential direction) of the hard magnetic body 35 of the magnetic body 31 according to the present invention.

As illustrated in FIGS. 2A and 2B, each magnetic body 131 according to this comparative embodiment is formed of only the hard magnetic body 135. The main difference between the rotary electric machine 111 according to this comparative embodiment and the rotary electric machine 11 according to the present invention lies in the point that the magnetic body 131 is produced from only the hard magnetic body 135.

The hard magnetic body 135 is made of hard magnetic material. Like the rotary electric machine 11 according to the present invention, as the hard magnetic material are used rare-earth element magnets, such as a neodymium magnet, having increased magnetic characteristics so as to achieve high torque density.

In an example shown in FIGS. 2A and 2B, one magnetic pole section 133 is constructed by combining a pair of first and second magnetic bodies 131A and 131B.

As used herein, the paired first and second magnetic bodies 131A and 131B are each generally and simply referred to as the “magnetic body 131”.

As shown in FIG. 2B, the paired magnetic bodies 131A and 131B are symmetric with respect to a radially extending center line 138, are inclined radially outward (see FIG. 2B), and are disposed like an approximately V-shape.

As shown in FIGS. 2A and 2B, in order to house the pair of magnetic bodies 131A and 131B, a pair of housing holes 139A and 139B is created in the rotor 115. Like the paired magnetic bodies 131A and 131B, the paired housing holes 139A and 139B are symmetric with respect to the center line 138, are inclined radially outward (see FIG. 2B), and are disposed like an approximately V-shape.

As used herein, the paired housing holes 139A and 139B are each generally and simply referred to as the “housing hole 139”.

While housed in each housing hole 139, each magnetic body 131 is fixed, using, for instance, an adhesive (not shown), to a radially inner wall surface of the housing hole 139 (see FIG. 1B).

Like the rotary electric machine 11 according to the present invention, paired magnetic bodies 131 included in one magnetic pole section 133 have the same magnet polarity on the radially outward side; and in each adjacent magnetic pole section 133, the magnet polarity is opposite.

[Advantageous Effects of Rotary Electric Machine 11 According to the Present Invention]

By appropriately referring to the Drawings, the following describes advantageous effects of each rotary electric machine 11 according to the present invention while compared to the rotary electric machine 111 according to the comparative embodiment.

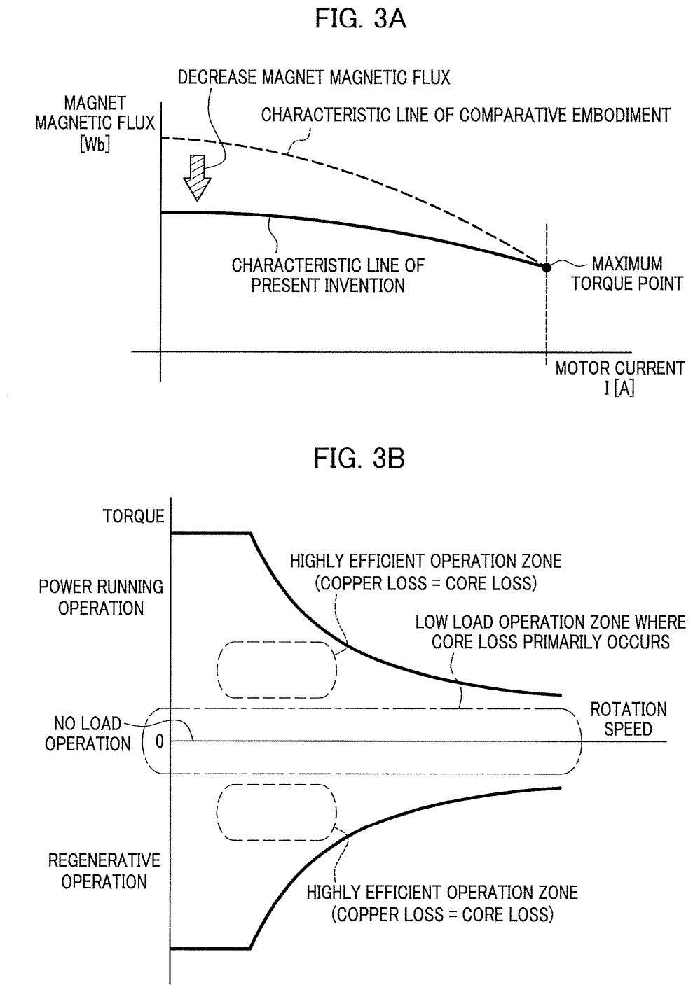

FIGS. 3A and 3B are diagrams illustrating cases where a rotary electric machine according to the present invention is needed in the art.

With reference to FIGS. 3A and 3B, the following describes the cases where a rotary electric machine 11 according to the present invention is needed in the art in which a rotary electric machine 111 according to a comparative embodiment is used. Then, the advantageous effects of the rotary electric machine 11 according to the present invention are explained.

The present inventors have conceived of the idea of why not decrease a magnet magnetic flux induced by a hard magnetic body 135 of each magnetic body 131, as an approach to realizing highly efficient operation of the rotary electric machine 111 according to the comparative embodiment. They have arrived at the finding that at that time, as illustrated in FIG. 3A, it is preferable to adequately decrease, over a relatively low load range of a motor current, the magnet magnetic flux induced by the hard magnetic body 135 of each magnetic body 131 while keeping the motor current-magnetic flux relationship at the maximum torque point where the maximum torque is produced (see the characteristic line of the present invention).

Meanwhile, FIG. 3B illustrates the rotation speed-torque characteristic lines. During power running operation, as the rotation speed increases, the torque tends to decrease. By contrast, during regenerative operation, reverse torque, which is in the direction opposite to the direction of the torque during power running operation, tends to decrease. The rotary electric machine 111 according to the comparative embodiment usually uses each highly efficient operation zone where the copper loss and the core loss are balanced (the copper loss=the core loss) as illustrated in FIG. 3B.

Here, the losses occurring during motor operation are largely grouped into two: a copper loss and a core loss. The copper loss refers to a loss caused by heating when a current flows through a copper wire. The core loss refers to a loss caused by heating when an eddy current occurs in a rotor core 127 and/or each magnetic body 131.

During high load operation over a low speed (high torque) range, a copper loss primarily occurs because the motor current is large. By contrast, during low load operation over a high speed (low torque) range, a core loss primarily occurs because the core loss is proportional to the frequency or the square of the frequency.

When a motor is designed, it is important to consider how to balance a copper loss and a core loss while paying attention to load points used. Basically, the design often involves setting the copper loss:the core loss to 1:1 in frequently used operation points.

Then, problems lie in the low load operation zone where the core loss primarily occurs as illustrated in FIG. 3B. This low load operation zone involves no load operation where the torque is 0. The no load operation means an operation mode in which electric cables wired to the rotary electric machine 111 are open. In the low load operation zone, a loss caused by the motor current is small (because the motor current is low). Meanwhile, the core loss is proportional to the magnet magnetic flux and tends to increase.

An issue is how to suppress, in such a low load operation zone, the magnet magnetic flux induced by the hard magnetic body 135 of each magnetic body 131.

Then, the rotary electric machine 11 based on the first aspect (corresponding to the invention according to claim 1) employs the following configuration so as to suppress, in the low load operation zone, the magnetic flux induced by each magnetic body 31 while keeping, in the high load operation zone, the magnetic flux induced by each magnetic body 31.

Specifically, each magnetic body 31 includes a hard magnetic body 35 and a soft magnetic body 37. The soft magnetic body 37 is stacked in a magnetization direction of the hard magnetic body 35. Each housing hole 39 houses the magnetic body 31 including the hard magnetic body 35 and the soft magnetic body 37.

In the rotary electric machine 11 based on the first aspect, when a motor current flows through each stator coil 25, a rotating magnetic field occurs at the stator 13. The rotating magnetic field as so generated at the stator 13 interacts with a magnetic field generated by each magnetic body 31 at the rotor 15, thereby driving rotation of the rotor 15 relative to the stator 13.

In the rotary electric machine 11 based on the first aspect, the soft magnetic body 37 of each magnetic body 31 at the rotor 15 is stacked in the magnetization direction of the hard magnetic body 35. On one hand, this configuration causes the soft magnetic body 37 to suppress the magnetic flux induced by the magnetic body 31 during low load operation when compared to the configuration of the rotary electric machine 111 according to the comparative embodiment. On the other hand, this configuration serves to enhance (maintain) the magnetic flux induced by the magnetic body 31 during high load operation.

Note that the soft magnetic body 37 is characterized in that the saturation magnetic flux density thereof is lower than the residual magnetic flux density of the hard magnetic body 35.

In the rotary electric machine 11 based on the first aspect, the magnetic flux induced by each magnetic body 31 during low load operation is more suppressed by using each soft magnetic body 37 than when the rotary electric machine 111 according to the comparative embodiment is used. By contrast, each soft magnetic body 37 exerts an effect of substantially maintaining the magnetic flux induced by each magnetic body 31 during high load operation.

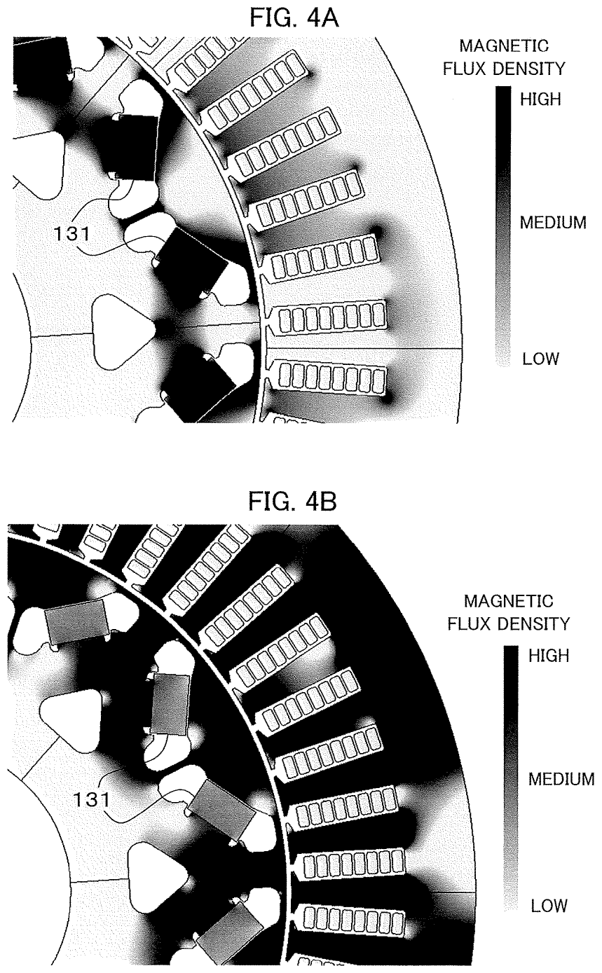

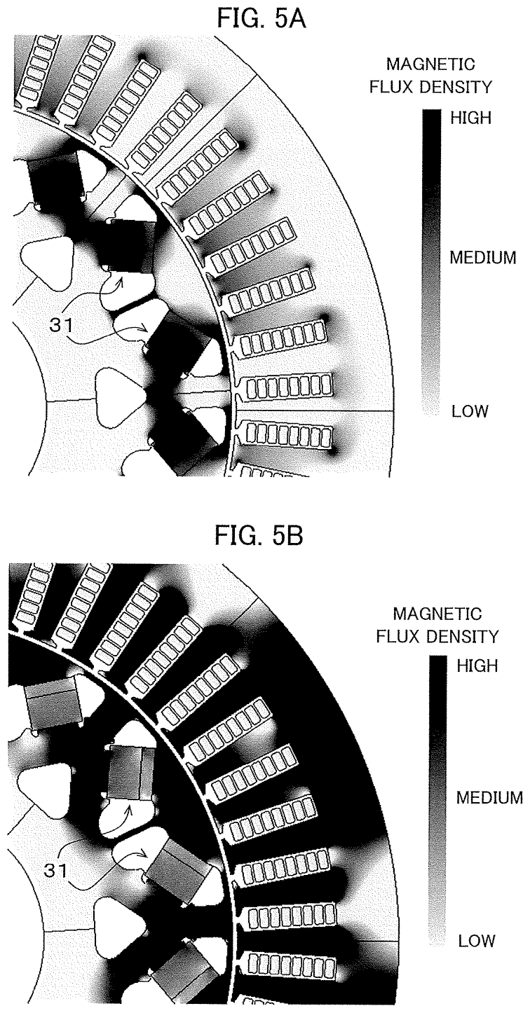

The above magnetic flux suppression/maintenance effects will be described by referring to FIGS. 4A and 4B according to the comparative embodiment and FIGS. 5A and 5B according to the present invention (based on the first aspect).

FIG. 4A is a contour plot illustrating a distribution of magnetic flux density at or near each magnetic body 131 in the rotary electric machine 111 according to the comparative embodiment (under no load: when the motor current is 0 A). FIG. 4B is a contour plot illustrating a distribution of magnetic flux density at or near each magnetic body 131 in the rotary electric machine 111 according to the comparative embodiment (under high load: when the motor current is about 100 A).

FIG. 5A is a contour plot illustrating a distribution of magnetic flux density at or near each magnetic body 31 in the rotary electric machine 11 according to the present invention (under no load: when the motor current is 0 A). FIG. 5B is a contour plot illustrating a distribution of magnetic flux density at or near each magnetic body 31 in the rotary electric machine 11 according to the present invention (under high load: when the motor current is about 100 A).

The comparative embodiment and the present invention under no load (under low load) are compared. In the case of each magnetic body 31 (see FIG. 5A) according to the present invention, the magnetic flux density is found to be lower than in the case of each magnetic body 131 (see FIG. 4A) according to the comparative embodiment. This means that the soft magnetic body 37 as part of each magnetic body 31 according to the present invention exerts an effect of suppressing, during low load operation, the magnetic flux induced by each magnetic body 31.

Then, the comparative embodiment and the present invention under high load are compared. In the case of each magnetic body 31 (see FIG. 5B) according to the present invention, the magnetic flux density is found to be equivalent to that in the case of each magnetic body 131 (see FIG. 4B) according to the comparative embodiment. This means that the soft magnetic body 37 as part of each magnetic body 31 according to the present invention exerts an effect of substantially maintaining, during high load operation, the magnetic flux induced by each magnetic body 31.

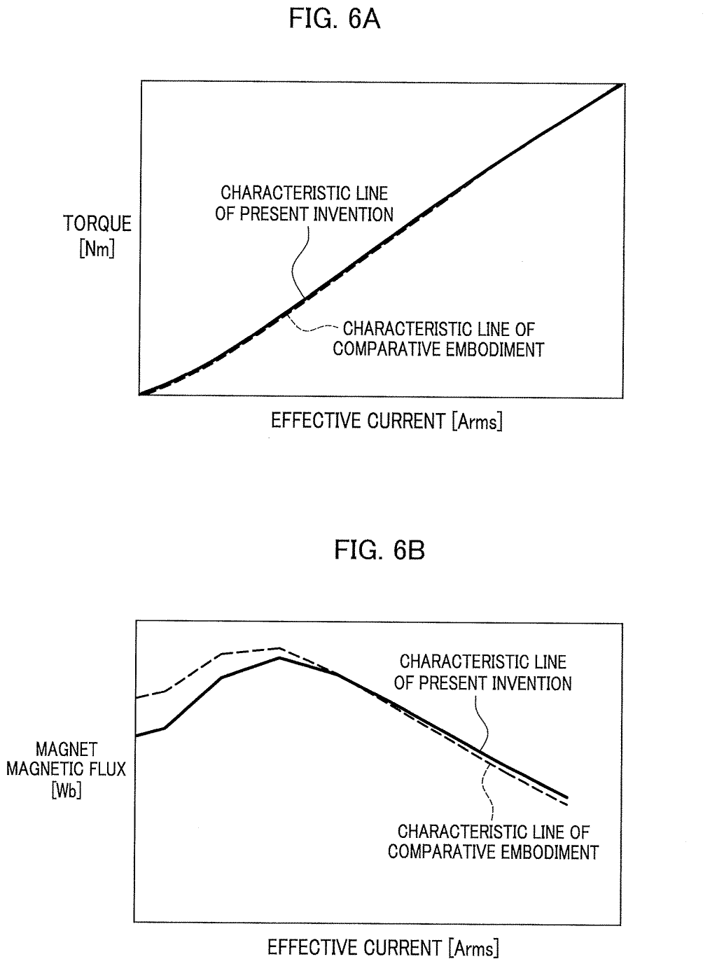

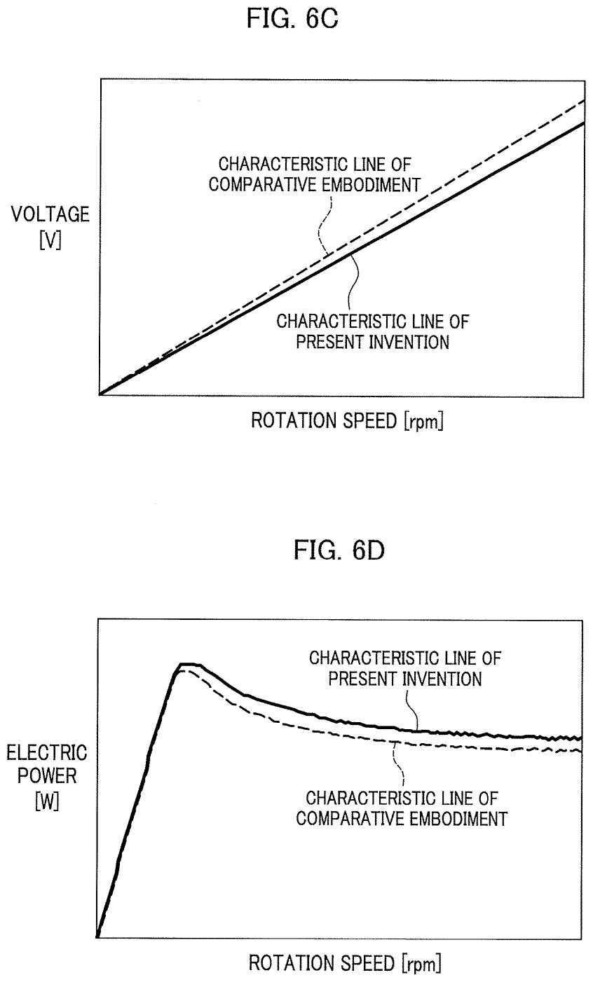

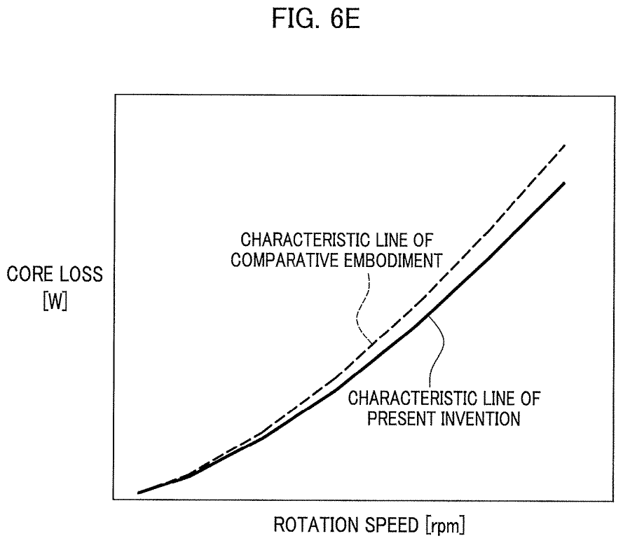

With reference to FIGS. 6A to 6E, the above magnetic flux suppression/maintenance effects will be described by comparing the comparative embodiment and the present invention.

FIG. 6A is a graph using characteristic lines to compare an effective current [Arms] vs. torque [Nm] change between the present invention and the comparative embodiment.

According to the graph (FIG. 6A) using characteristic lines to compare an effective current vs. torque change between the present invention and the comparative embodiment, the output (i.e., a function of the rotation speed and the torque) of the rotary electric machine 11 is found to remain substantially unchanged between the rotary electric machine 11 according to the present invention and the rotary electric machine according to the comparative embodiment.

FIG. 6B is a graph using characteristic lines to compare an effective current [Arms] vs. magnet magnetic flux [Wb] change between the present invention and the comparative embodiment.

According to the graph (FIG. 6B) using characteristic lines to compare an effective current vs. magnet magnetic flux change between the present invention and the comparative embodiment, the magnet magnetic flux of the rotary electric machine 11 under low load is found to be lower in the rotary electric machine 11 according to the present invention than in the rotary electric machine according to the comparative embodiment.

FIG. 6C is a graph using characteristic lines to compare a rotation speed [rpm] vs. voltage [V] change between the present invention and the comparative embodiment. FIG. 6D is a graph using characteristic lines to compare a rotation speed [rpm] vs. electric power [W] change between the present invention and the comparative embodiment.

According to the graphs (FIGS. 6C and 6D) using characteristic lines to compare a rotation speed vs. voltage/electric power change between the present invention and the comparative embodiment, the counter electromotive force of the rotary electric machine 11 is found to be lower in the rotary electric machine 11 according to the present invention than in the rotary electric machine according to the comparative embodiment.

FIG. 6E is a graph using characteristic lines to compare a rotation speed [rpm] vs. core loss [W] change under no load between the present invention and the comparative embodiment.

According to the graph (FIG. 6E) using characteristic lines to compare a rotation speed vs. core loss change under no load between the present invention and the comparative embodiment, the loss of the rotary electric machine 11 under no load is found to decrease by about 10% in the rotary electric machine 11 according to the present invention when compared to the rotary electric machine according to the comparative embodiment.

The rotary electric machine 11 (according to the present invention) based on the first aspect has been compared with the rotary electric machine 111 according to the comparative embodiment. On one hand, the soft magnetic body 37 can suppress the magnet magnetic flux induced by each magnetic body 31 during low load operation. On the other hand, the soft magnetic body 37 exerts an effect of substantially maintaining the magnet magnetic flux induced by each magnetic body 31 during high load operation. This makes it possible to produce, without causing the weight and size to increase, a highly efficient operation-achievable rotary electric machine 11.

In other words, the rotary electric machine 11 based on the first aspect makes it possible to enlarge the practical range of each output parameter including the rotation speed and the torque, which range allows for a highly efficient operation.

Note that according to the rotary electric machine 11 based on the first aspect, the magnet magnetic flux induced by each magnetic body 31 during low load operation is suppressed. Accordingly, when a magnetic flux-weakening control is needed, for instance, an effect of decreasing the level of the control should be exerted.

In the rotary electric machine 11 based on the second aspect (corresponding to the invention according to claim 2), the thickness of the soft magnetic body 37 in the magnetization direction of the hard magnetic body 35 is thinner than the thickness of the hard magnetic body 35.

According to the rotary electric machine 11 based on the second aspect, the thickness of the soft magnetic body 37 is thinner than the thickness of the hard magnetic body 35. This makes it possible to exert, in addition to the advantageous effects of the rotary electric machine 11 based on the first aspect, an effect of reducing the size of the whole magnetic body 31 in the thickness direction.

In the rotary electric machine 11 based on the third aspect (corresponding to the invention according to claim 3), the soft magnetic body 37 is produced by layering a plurality of soft magnetic materials.

According to the rotary electric machine 11 based on the third aspect, the soft magnetic body 37 is produced by layering a plurality of soft magnetic materials. This should make it possible to exert, in addition to the advantageous effects of the rotary electric machine 11 based on the first aspect, an effect of decreasing an eddy current occurring in the soft magnetic body 37 when the magnet magnetic flux in the magnetization direction changes.

In the rotary electric machine 11 based on the fourth aspect (corresponding to the invention according to claim 4), a layer surface on which the soft magnetic materials are each layered extends in a direction perpendicular to the magnetization direction (see, the first soft magnetic body 37-1 having the first layered structure shown in FIGS. 1C to 1F and the third soft magnetic body 37-3 having the third layered structure shown in FIG. 1L).

According to the rotary electric machine 11 based on the fourth aspect, a layer surface on which the soft magnetic materials are each layered extends in a direction perpendicular to the magnetization direction. This makes it possible to decrease, while the number of layers of the soft magnetic materials included in the soft magnetic body 37 is reduced, eddy-current losses occurring in the soft magnetic body 37 when the magnet magnetic flux in the magnetization direction changes.

In the rotary electric machine 11 based on the fifth aspect (corresponding to the invention according to claim 5), a layer surface on which the soft magnetic materials are each layered extends in the magnetization direction (see, the second soft magnetic body 37-2 having the second layered structure shown in FIGS. 1G to 1K and the third soft magnetic body 37-3 having the third layered structure shown in FIG. 1L).

According to the rotary electric machine 11 based on the fifth aspect, a layer surface on which the soft magnetic materials are each layered extends in the magnetization direction. This makes it possible to further decrease eddy-current losses occurring in the soft magnetic body 37 when the magnet magnetic flux in the magnetization direction changes.

In the rotary electric machine 11 based on the sixth aspect (corresponding to the invention according to claim 6), the soft magnetic body is characterized in that the saturation magnetic flux density thereof is lower than the residual magnetic flux density of the hard magnetic body. This makes the soft magnetic body 37 serve to decrease a magnetic flux induced by the hard magnetic body 35.

According to the rotary electric machine 11 based on the sixth aspect, the soft magnetic body 37 serves to decrease a magnet magnetic flux induced by the hard magnetic body 35. This makes it possible to further decrease eddy-current losses occurring in the soft magnetic body 37 when the magnet magnetic flux in the magnetization direction changes.

The invention based on the seventh aspect (corresponding to the invention according to claim 7) provides a vehicle carrying, as a driving source, the rotary electric machine 11 based on any one of the first to sixth aspects.

The invention based on the seventh aspect makes it possible to produce a vehicle carrying, without causing the weight and size to increase, a highly efficient operation-achievable rotary electric machine 11 as a driving source.

### Other Embodiments

The above-described embodiments are examples to be embodied in the present invention. Accordingly, they should not be construed such that the technical scope of the present invention is limited. This is because the present invention can be put into practice, without departing from the spirit and the main features thereof, even in various embodiments.

For instance, in the description of each rotary electric machine 11 according to the present invention, exemplified is an embodiment in which the soft magnetic body 37 is stacked, radially outward of the hard magnetic body 35, in the magnetization direction of the hard magnetic body 35. However, the present invention is not limited to this embodiment.

In one embodiment, the soft magnetic body 37 may be stacked, radially inward of the hard magnetic body 35, in the magnetization direction of the hard magnetic body 35.

In another embodiment, the hard magnetic body 35 may be divided into multiple pieces in the magnetization direction; and the soft magnetic body 37 may be stacked such that the soft magnetic body 37 is sandwiched between the divided hard magnetic body 35 pieces.

In the description of the basic structure of each rotary electric machine 11 according to the present invention, the number and the form of magnetic bodies 31 or housing holes 39, which are components of the magnetic pole section 33, may be arbitrary as long as they do not hinder the rotation performance of the rotary electric machine 11.

In addition, in the description of the basic structure of each rotary electric machine 11 according to the present invention, exemplified is an embodiment of the rotary electric machine 11 including “12” magnetic pole sections 33 and “72” slots 23. However, the present invention is not limited to this embodiment.

The number of magnetic pole sections 33 or slots 23 may be arbitrary as long as they do not hinder the rotation performance of the rotary electric machine 11.

Further, in the description of the basic structure of each rotary electric machine 11 according to the present invention, the height (size in the radial direction) and the width (the size in the circumferential direction) of each magnetic body 31 having a rectangular cross section may be appropriately set by comparing and considering target output characteristics and the experimentation/simulation results of the effects of the rotary electric machine 11 on the output characteristics.

### REFERENCE SIGNS LIST

11 Rotary electric machine according to the present invention
13 Stator
15 Rotor
21 Stator core
25 Stator coil (Coil)
31 Magnetic body
35 Hard magnetic body
37 Soft magnetic body
39 Housing hole

1. A rotary electric machine comprising:
an annular stator comprising a stator core and coils included in the stator core; and
an annular rotor comprising a rotor core and a plurality of housing holes for magnetic bodies extending in a drive shaft direction, the housing holes being arranged in a circumferential direction, the rotor facing, via a gap, an inner periphery of the stator,
wherein each magnetic body comprises a hard magnetic body and a soft magnetic body;
the soft magnetic body is stacked in a magnetization direction of the hard magnetic body; and
each housing hole houses the magnetic body comprising the hard magnetic body and the soft magnetic body.

2. The rotary electric machine according to claim 1, wherein a thickness of the soft magnetic body in the magnetization direction of the hard magnetic body is thinner than a thickness of the hard magnetic body.

3. The rotary electric machine according to claim 1, the soft magnetic body is produced by layering a plurality of soft magnetic materials.

4. The rotary electric machine according to claim 3, wherein a layer surface on which the soft magnetic materials are each layered extends in a direction perpendicular to the magnetization direction.

5. The rotary electric machine according to claim 3, wherein a layer surface on which the soft magnetic materials are each layered extends in the magnetization direction.

6. The rotary electric machine according to claim 3, wherein the soft magnetic body is characterized in that a saturation magnetic flux density thereof is lower than a residual magnetic flux density of the hard magnetic body.

7. A vehicle comprising, as a driving source, the rotary electric machine according to claim 1.
